(19) United States
(12) Patent Application Publication
(10) Pub. No.: US 2014/0023137 A1
(43) Pub. Date: Jan. 23, 2014

(54) TECHNIQUES FOR CONTEXT-ADAPTIVE BINARY DATA ARITHMETIC CODING (CABAC) DECODING

(71) Applicant: Richard Edwin Goedeken, Santa Clarita, CA (US)

(72) Inventor: Richard Edwin Goedeken, Santa Clarita, CA (US)

(73) Assignee: THOMSON LICENSING, Issy de Moulineaux (FR)

(21) Appl. No.: 14/008,366

(22) PCT Filed: Mar. 31, 2011
(86) PCT No.: PCT/US2011/000578

§ 371 Date: Sep. 27, 2013

(51) Int. Cl. H04N 7/26

(52) U.S. Cl. CPC H04N 19/00121
USPC 375/240.02

(57) ABSTRACT

A method for decoding of transform coefficients. The method comprises decoding consecutive bits of an input compressed bitstream; computing a first symbol value using a number of decoded bits; returning the first symbol value if a total number of decoded bits is less than a specified bit count; computing a second symbol value if the total number of decoded bits equals the specified bit count; and returning the second symbol value.

### FIELD OF THE INVENTION

The present invention generally relates to video data decoders and encoders, and more particularly to techniques for optimizing such decoders and encoders.

### BACKGROUND OF THE INVENTION

In the related art a recent effort is performed to parallelize the processing tasks and in particular video processing tasks. This becomes a critical task as, on one hand the video processing is very computationally expensive, but on the other hand, the processing power of a single processor cannot be further increased. A prime example is the H.264 video standard published by the ITU-T in March 2008 (hereinafter the “H.264 standard”). In order to support advanced applications, decoders and encoders compliant with the H.264 standard must be parallelized. Parallelization typically includes breaking a single task into multiple sub-tasks and processing sub-tasks simultaneously.

However, the execution of the H.264 decoders/encoders cannot be entirely parallelized due to the context-adaptive binary data arithmetic coding (CABAC). The CABAC is a data compression/coding process carried out by the H.264 video decoder. The CABAC process is entirely sequential, i.e., for each process step, the required input data is dependent upon the output data from the previous step. Due to this dependency, the CABAC decoding process of a chunk of compressed data cannot be split into sub-tasks and run on parallel processors.

One such CABAC decoding process is performed during the transform coefficients decoding process, where an array of 16 or 64 transform coefficients is decompressed from a CABAC data stream. The overall order of operations for decoding a 4×4 or 8×8 sub-macroblock array during this transform coefficients decoding process includes the following steps: 1) decoding the total number of non-zero transform coefficients; 2) decoding the index value of the last non-zero transform coefficient; 3) decoding a binary map giving the index values of all non-zero transform coefficients; and 4) for each non-zero transform coefficient in the map: decode one bit at a time until either a zero-bit is encountered or a specified number of bits/(e.g., I=14) have been decoded; and if a specified number of bits were decoded, then decoding the coefficient value using a bypass encoded (uncompressed) Exp-Golomb code.

The last step (4) is typically performed by running a loop on a general-purpose CABAC bit decoding function until a specified bit count or a zero-bit is encountered. The pseudo-code for executing this step may be presented as follows:

do {
bit = decode_binary_decision (CABAC, bitstream, context) ;
symbol = symbol + 1;
} while ((bit == 1) && (symbol < (unary_max − 1)));

The decode_binary_decision is a general-purpose CABAC bit decoding function where its input parameters are a CABAC object, a compressed bitstream to be decoded, and a context associated with the type of decoded data. There are many different types of data included in the compressed data stream. For example, such data types include motion vectors, macroblock modes, prediction types, and flags. Each different type of data uses its own predefined context in the CABAC decoder. The decoder decodes each bit based on its context.

Consequently, for a high performance H.264 video decoder designed to run on parallel processing hardware, the CABAC decoding is a performance bottleneck which in many cases determines the overall performance of the video decoder.

It would be, therefore, advantageous to provide a solution for accelerating the execution of a CABAC decoding process.

### SUMMARY OF THE INVENTION

Certain embodiments of the invention include a method for performing a transform coefficients decoding process. The method comprises decoding consecutive bits of an input compressed bitstream; computing a first symbol value using a number of decoded bits; returning the first symbol value, if a total number of decoded bits is less than a specified bit count; computing a second symbol value, if the total number of decoded bits equals the specified bit count; and returning the second symbol value.

Certain embodiments of the invention also include a decoder for decoding transform coefficients. The decoder comprises a context-adaptive binary data arithmetic coding (CABAC) decoder for decoding consecutive bits of an input compressed bitstream; a first adder for computing a first symbol value by adding one to a number of decoded bits; a comparator for determining if a total number of decoded bits equal to a specified bit count; an Exponential-Golomb code decoder for decoding the input compressed bitstream if the total number of decoded bits equal to the specified bit count; and a second adder for generating a second symbol value by adding the first symbol value to a result generated by the Exponential-Golomb code decoder.

### BRIEF DESCRIPTION OF THE DRAWINGS

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIG. 1 is a flowchart illustrating a method for optimizing the transform coefficient decoding process as implemented in accordance with an embodiment of the invention.

FIG. 2 is a flowchart illustrating a process for decoding bits having the same context implemented in accordance with an embodiment of the invention.

FIG. 3 is a flowchart illustrating a process for decoding consecutive bits implemented in accordance with an embodiment of the invention.

FIG. 4 is a block diagram of decoder constructed in accordance with an embodiment of the invention.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In accordance with the principles of the invention the techniques disclosed herein are performed during the transform coefficients decoding process defined in the H.264 standard, where an array of 16 or 64 transform coefficients is decompressed from a CABAC bitstream. Specifically, the disclosed techniques are designed to optimize the sub-process of decoding one bit at a time until either a zero-bit is encountered or a specified bit count is reached. This sub-process is performed for each non-zero transform coefficient.

In accordance with the principles of the invention the method is achieved by decoding consecutive bits with the same value, using the same CABAC context, until a specified bit count or a zero-bit is encountered. This functionality can be presented using the following pseudo code:

symbol=1+decode_consecutive(cabac,bitstream,context,1,unary_max−1)

It should be appreciated that two levels of optimization are achieved using this approach. A first level is reducing the execution overhead by eliminating the repetitive calls to the general-purpose CABAC bit decoding function (decode_binary_decision) and a second level of optimization is achieved by decoding consecutive bits with the same value.

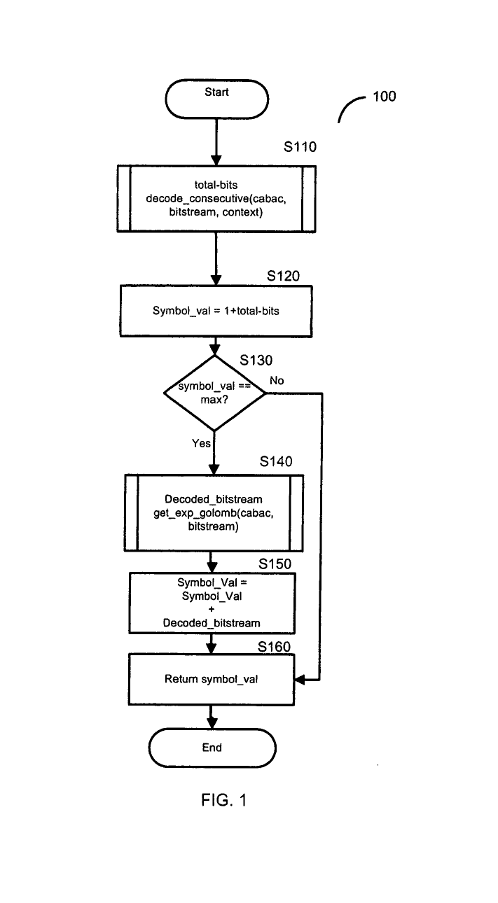

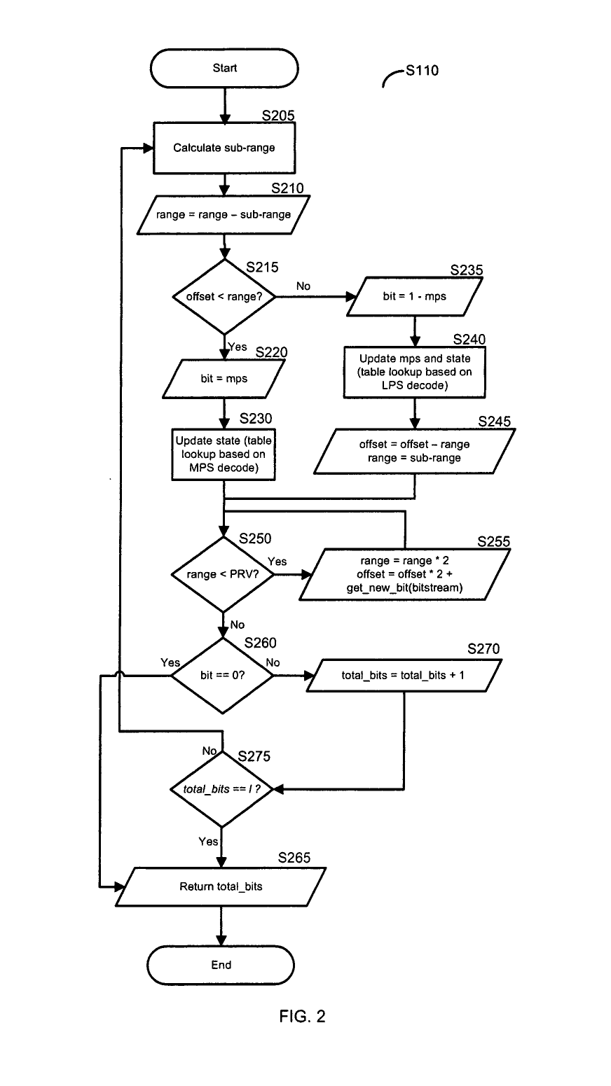

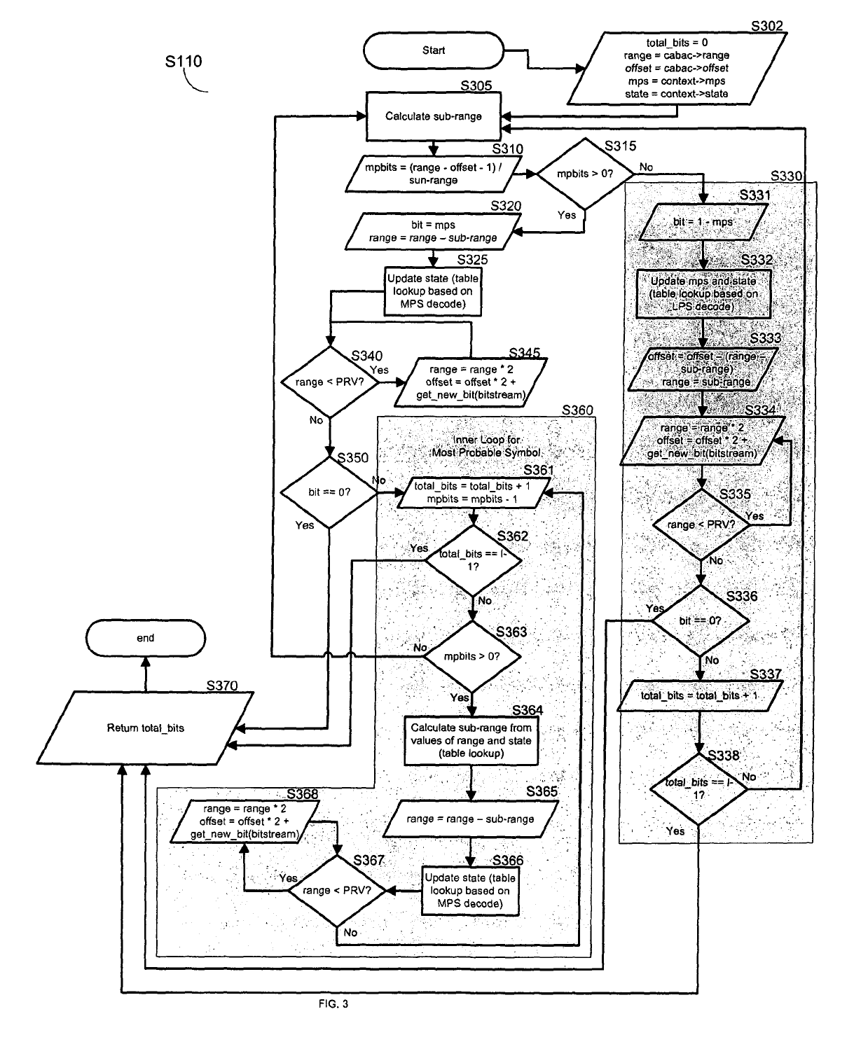

FIG. 1 shows an exemplary and non-limiting flowchart 100 illustrating the method for optimizing the transform coefficients decoding process as implemented in accordance with an embodiment of the invention. At S110, a process (decode_consecutive) for decoding consecutive bits with the same context value is performed. This process receives three input parameters: a reference to the context for which the bit will be decoded, a reference to the compressed bitstream and a reference to the CABAC decoder object including the range and offset integer values. Step S110 generates a decompressed bitstream and returns the number of decoded bits. In accordance with an embodiment of the invention, the decode_consecutive process decodes, at each iteration, multiple same-valued bits from the decoded CABAC bitstream using the same context. In accordance with another embodiment, the decode_consecutive process is based on computing a minimum number of consecutive most probable symbol (MPS) bits and then advancing the state machine of the CABAC decoder for each bit in a tight loop without checking the value of each bit. The execution of S110 is described in greater detail below with reference to FIGS. 2 and 3.

At S120, a symbol value is computed as the total number of decoded bits by the decode_consecutive process plus 1. That is, symbol value=total bits+1. At S130, it is checked if the total number of decoded bits equal to a specified bit count (I). If so, execution continues with S140; otherwise, the symbol value is returned (S160) and execution ends.

At S140, the compressed bitstream is decoded using an Exponential-Golomb code. At S150, the symbol value is computed by adding the symbol value computed at S120 to the decoded bitstream generated at S140. Thereafter, execution continues with S160. As can be understood from the above description and flowchart 100, the process decode_consecutive is called only once and not for each bit in the bitstream, thereby accelerating the execution of the transform coefficients decoding process.

FIG. 2 shows an exemplary and non-limiting flowchart S110 illustrating the decode_consecutive process for decoding bits having the same context as implemented in accordance with an embodiment of the invention. As mentioned above the input parameters of the process are the context, bitstream, and CABAC decoder object including the range and offset integer values. The process generates a decompressed bitstream and returns the number of decoded bits.

A data type of a bitstream uses its own context in a CABAC decoder. Each context in the CABAC decoder has two state information parameters: a value of a most probable symbol (MPS) which may be either ‘1’ or ‘0’ for the context and a state integer which designates the relative probability of the most probable symbol. It is useful to distinguish between the MPS and a least probable symbol (LPS) for the purpose of identifying binary decisions as either MPS or LPS, rather than ‘0’ or ‘1’. The CABAC decoder keeps two additional parameters: a range integer and an offset integer which are required to decode any bits regardless of context. The range and offset values encapsulate the lowest level state information about the CABAC decoder. These two values must be used as a pair, neither has any meaning without the other.

At S205, a sub-range value is computed using the values of the context's state parameter and the range parameter of the CABAC. This step includes computing a rough range value, and finding a sub-range value in a lookup table using the rough range and context state values. One possible implementation for step S205 can be found in the H.264 standard page 238. It should be noted that when a particular CABAC context's state is heavily biased towards the most probable symbol, the value of the sub-range is relatively small. At S210, a new range value is computed by subtracting the sub-range value from the range value of the CABAC decoder (i.e., range=range−sub-range).

At S215, a check is made to determine if the offset value of the CABAC decoder is less than the computed new range value. If so, at S220, a decompressed output bit having a value equals to the MPS value is returned. Then, at S230, the context's state parameter is updated to indicate that the most probable symbol is even more probable, for example, by increasing the value of the state parameter.

If S215 results with a negative answer, execution continues with S235 where a decompressed output bit having a value equals to a LPS value is returned (i.e., LPS value=1−MPS value). Thereafter, at S240, the state parameter of the context is updated to indicate that the most probable symbol is less probable than before, and the value of the most probable symbol may be inverted. At S245, a new offset value is computed by subtracting the range value from the offset value. In addition, the range value is set to the sub-range value. It should be apparent to a person skilled in the art that the steps S215, 220 and 235 are based on arithmetic coding, which allows decoding bits using the offset and range values and known probabilities of the MPS and LPS.

At S250, a check is made to determine if the new range value is less than a predefined range value (PRV). If so, at S255, both the range and offset values are multiplied by 2 and adding to the offset value a new bit that was read from the compressed bitstream. Thereafter, execution returns S250. In one embodiment the PRV is set to 256 as defined in the H.264 standard. It should be noted that steps S250 and S255 are part of a renormalization process performed by a CABAC decoder.

If S250 results with a ‘No’ answer, at S260, a check is made to determine if a zero-bit was encountered. If so, at S265, the total number of bits that were decoded is returned. In addition, the range and offset parameters of the CABAC decoder as well as the context's most probable symbol and state may be updated to their computed values. If a zero-bit was not encountered, then at S270, the number of total bits that were decoded is incremented by 1. At S275, it is checked if the number of total bits is equal to the specified bit count (I) for the number of bits that should be decoded minus 1 (e.g., I−1), and if so execution continues with S265; otherwise, execution returns to S205.

FIG. 3 shows an exemplary and non-limiting flowchart S110 illustrating the decode_consecutive process implemented in accordance with another embodiment of the invention. The process generates a decompressed bitstream and returns the number of decoded bits. In this embodiment the decoding is based on computing a minimum number of consecutive most probable symbol bits and then advancing the state machine of the CABAC decoder for each bit in a tight loop without having to check for the value of each bit.

At S302, input parameters including context and its state and MPS parameters, a compressed bitstream, and a CABAC decoder object including the range and offset integer values are received. At S305, a sub-range value is calculated using the values of the state parameter of the context and the range parameter of the CABAC decoder. At S310, a minimum number of consecutive most probable symbol bits (mpbits) in the input bitstream is computed using the sub-range, range and offset values. In one embodiment, the mpbits is computed using the following equation:

mpbits={(range−offset)−1}/sub-range.

At S315, a check is made to determine if the mpbits value is greater than 0, i.e., if there is at least one most probable symbol bits in the bitstream. If so, execution continues with S320; otherwise, at S330 bits in the bitstream are decoded, each bit at a time, according to the LPS value.

Specifically, step S330 includes returning a decompressed output bit having a value equals to the LPS value (S331); updating the context's state and MPS value to indicate that the most probable symbol is less probable than before (S332); computing a new offset value by subtracting the range value from the offset value; setting the range value to the sub-range value (S333); performing a renormalization process (S334 and S335); when the renormalization process is completed, checking whether a zero-bit was encountered (S336), and if so, proceeding to S370 where the total number of bits that were decoded is returned; otherwise, incrementing the number of total bits that were decoded by 1 (S337); and checking if the total number of bits is equal to a specified bit count for the number of bits (I) that should be decoded minus 1 (S338), and if so continuing with S370; otherwise, returning to S305.

Execution reaches to S320 if there is at least one bit with a most probable symbol (MPS) value. Thus, a decompressed output bit having a value equals to the MPS value is returned. In addition, at S320 a new range value is calculated. At S325, the context's state parameter is updated to indicate that the most probable symbol is even more probable, for example, by increasing the value of the state parameter. At S340 and S345 a renormalization process is performed as described above.

If the new range value is equal to or bigger than a PRV, at S350, a check is made to determine if a zero-bit was encountered. If so, at S370, the total number of bits that were decoded is returned. In addition, the range and offset parameters of the CABAC decoder as well as the context's most probable symbol and state may be updated to their computed values. If no zero-bit was encountered, execution continues with S360 where an inner loop procedure for handling MPS consecutive bits having the same value is performed.

Specifically, S360 allows for advancing the state machine of the CABAC decoder for each bit in the MPS consecutive bits without checking the value of each bit. This is particularly useful in cases where large-valued transform coefficients are encoded with unary codes. In such cases, each bit has a high probability of being ‘1’ and a low probability of being ‘0’. For example, if a transform coefficient with a value of 10 is encoded with unary codes, the resulting binary data is 1111111110. During the execution of S360 the CABAC decoder is advanced without decoding the 1-bits, thereby significantly reducing the time required to decode the entire bitstream.

The execution of S360 includes incrementing the number of total bits that were decoded by 1 and decrementing the mpbits value by 1 (S361); checking if the total number of bits is equal to a specified bit count for the number ofbits (I) that should be decoded minus 1 (S362); and if so continuing with S370; otherwise, checking if the mpbits value is greater than 0 (S363), and if so calculating a sub-range value using the range and state values (S364); computing a new range value by subtracting the sub-range value from the range value (S365); updating context's state parameter to indicate that the most probable symbol is even more probable (S366); performing a renormalization process (S367, S368); and, returning to S361 if the new range value is bigger than or equal to the PRV.

It should be appreciated that the optimization technique described herein is particular useful in H.264 high quality video applications, as typically in such application a video stream is encoded at a high bit rate. The encoded stream contains many large-valued transform coefficients in the residual data. This residual data occupies a large portion of the total data encoded in high-quality bitstreams. Furthermore, large-valued transform coefficients are encoded with unary codes, each bit has a high probability of being ‘1’ and a low probability of being ‘0’. As mentioned in greater detail above, step S360 was designed to accelerate the decoding of unary codes, thereby of large-valued transform coefficients.

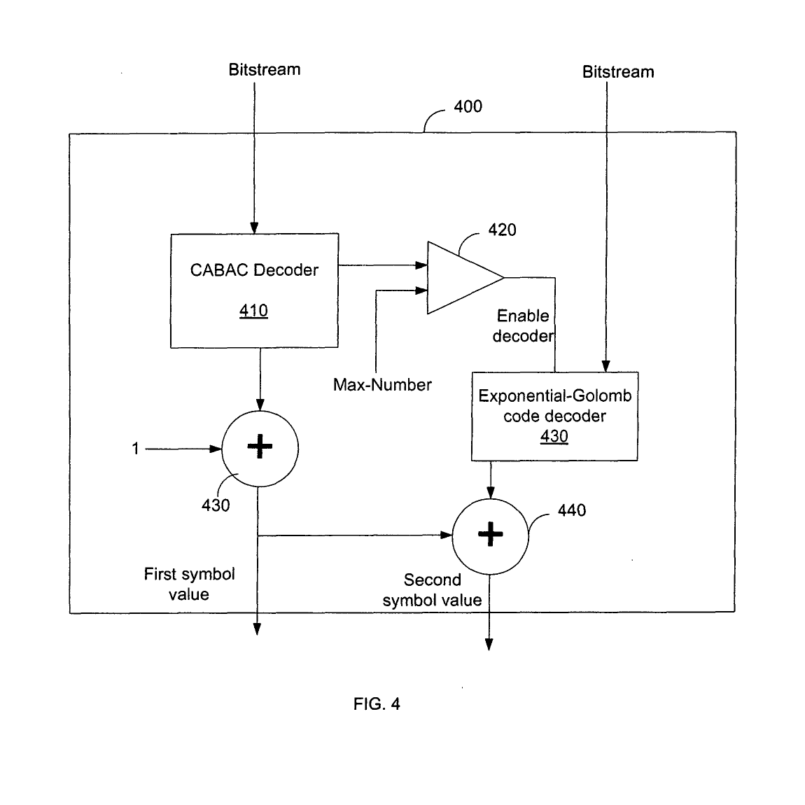

FIG. 4 is an exemplary and non-limiting diagram of a decoder 400 for decoding transform coefficients implemented in accordance with an embodiment of the invention. The decoder 400 includes a context-adaptive binary data arithmetic coding (CABAC) decoder 410 for decoding consecutive bits of an input compressed bitstream. The CABAC decoder 110 performs the decode_consecutive described in detail above. The CABAC decoder 110 can operate in two modes. The first mode includes decoding multiple same-valued bits from the decoded CABAC bitstream using the same context. The second mode include computing a minimum number of consecutive most probable symbol (MPS) bits and then advancing the state machine of the CABAC decoder for each bit in a tight loop without checking the value of each bit.

The decoder 400 also comprises a first adder 430 for computing a first symbol value by adding the integer number one to a total number of decoded bits decoded by the CABAC decoder 410; a comparator 420 for determining if the total number of decoded bits equal to a specified bit count; an Exponential-Golomb code decoder 430 for decoding the input compressed bitstream if the total number of decoded bits equal to the specified bit count and a second adder 440 for generating a second symbol value by adding the first symbol value to a result generated by the Exponential-Golomb code decoder 430.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

Most preferably, the principles of the invention are implemented as any combination of hardware, firmware and software. Moreover, the software is preferably implemented as an application program tangibly embodied on a program storage unit or computer readable medium. One of ordinary skill in the art would recognize that a “machine readable medium” is a medium capable of storing data and can be in a form of a digital circuit, an analogy circuit or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

1. A method for decoding transform coefficients, comprising:
decoding consecutive bits of an input compressed bitstream;
computing a first symbol value using a number of the decoded bits;
returning the first symbol value, if a total number of the decoded bits is less than a specified bit count;
computing a second symbol value, if the total number of the decoded bits equals the specified bit count; and
returning the second symbol value.

2. The method of claim 1, wherein computing the first symbol value further comprising:
adding one to the total number of the decoded bits.

3. The method of claim 1, wherein computing the second symbol value further comprises:
decoding the input compressed bitstream using an Exponential-Golomb code; and
adding the first symbol value to a result generated by the Exponential-Golomb code decoding.

4. The method of claim 1, wherein the input compressed bitstream is a decoded context-adaptive binary data arithmetic coding (CABAC) bitstream.

5. The method of claim 4, wherein decoding the consecutive bits, further comprising:
decoding multiple bits having a same value using a same CABAC context.

6. The method of claim 5, further comprising:
receiving a context value, the input compressed bitstream, and a CABAC decoder object, wherein the CABAC decoder object includes a range value and an offset value;
computing a sub-range value;
computing a new range value by subtracting the sub-range value from the range value;
checking if the offset value is less than the new range value;
returning a decompressed output bit having a value equal to a most probable symbol (MPS) value, if the offset is less than the new range value; and
returning a decompressed output bit having a value equal to a least probable symbol (LPS), if the offset is bigger or equal to the new range value.

7. The method of claim 6, further comprising:
performing a renormalization process;
checking if a zero bit is encountered;
returning a total number of the decoded bits, if a zero bit is encountered;
incrementing a counter counting the total number of the decoded bits, if a zero bit is not encountered; and
returning the total number of the decoded bits, if a specified maximum number of bits were decoded.

8. The method of claim 7, wherein performing the renormalization process comprises:
consecutively reading new bits from the input compressed bitstream until a range value is bigger than or equal to a predefined range value (PRV).

9. The method of claim 1, wherein decoding the consecutive bits comprises:
computing a minimum number of consecutive most probable symbol bits in the input compressed bitstream; and
advancing a state machine of a CABAC decoder for each bit in the consecutive most probable symbol bits without checking the value of each bit.

10. The method of claim 9, further comprising:
receiving a context value, the input compressed bitstream, and a CABAC decoder object, wherein the CABAC decoder object includes a range value and an offset value;
computing a sub-range value using the range value and the offset value;
computing a minimum number of consecutive most probable symbol bits (mpbits) in the input compressed bitstream;
returning a decompressed output bit having a value equals to a most probable symbol value, if the minimum number of consecutive most probable symbol bits is greater than zero; and
returning a decompressed output bit having a value equals to a least probable symbol value, if the minimum number of consecutive most probable symbol bits is equal to zero.

11. The method of claim 10, wherein returning the decompressed output bit having a value equal to the most probable symbol value, further comprising:
computing a new range value by subtracting the range value from the sub-range value;
performing a normalization process;
upon completion of the normalization process, checking if a zero bit is encountered in the consecutive most probable symbol bits;
iteratively advancing the state machine of the CABAC decoder for each bit in most probable symbol consecutive bits, if a zero bit is not encountered; and
returning a total number of decoded bits when the zero bit is encountered or a specified bit count is achieved.

12. A computer readable medium having stored thereon instructions which, when executed by a computer, perform a method for decoding transform coefficients, comprising:
decoding consecutive bits of an input compressed bitstream;
computing a first symbol value using a number of the decoded bits;
returning the first symbol value, if a total number of the decoded bits is less than a specified bit count;
computing a second symbol value, if the total number of the decoded bits equals the specified bit count; and
returning the second symbol value.

13. A decoder for decoding transform coefficients, comprising:
a context-adaptive binary data arithmetic coding (CABAC) decoder for decoding consecutive bits of an input compressed bitstream;
a first adder for computing a first symbol value by adding one to a number of the decoded bits;
a comparator for determining if a total number of the decoded bits equal to a specified maximum number;
an Exponential-Golomb code decoder for decoding the input compressed bitstream if the total number of the decoded bits equal to the specified bit count; and
a second adder for generating a second symbol value by adding the first symbol valve to a result generated by the Exponential-Golomb code decoder.

14. The decoder of claim 4, wherein decoding the consecutive bits, further comprising:
decoding multiple bits having a same value using a same CABAC context.

15. The decoder of claim 14, further comprising:
receiving a context value, the input compressed bitstream, and a CABAC decoder object, wherein the CABAC decoder object includes a range value and an offset value;
computing a sub-range value;
computing a new range value by subtracting the range value from the sub-range value;
checking if the offset value is teas than the new range value;
returning a decompressed output bit having a value equal to a most probable symbol (MPS) value, if the offset is less than the new range value; and
returning a decompressed output bit having a value equal to a least probable symbol (LPS), if the offset is bigger or equal to the new range value.

16. The decoder of claim 15, further comprising:
performing a renormalization process;
checking if a zero bit is encountered;
returning a total number of the decoded bits, if a zero bit is encountered;
incrementing a counter counting the total number of the decoded bits, if a zero bit is not encountered; and
returning the total number of decoded bits, if a specified maximum number of bits were decoded.

17. The decoder of claim 16, wherein performing the renormalization process comprises:
consecutively reading new bits from the input compressed bitstream until a range value is bigger than or equal to a predefined range value (PRV).

18. The decoder of claim 13, wherein decoding the consecutive bits comprises:
computing a minimum number of consecutive most probable symbol bits in the input compressed bitstream; and
advancing a state machine of a CABAC decoder for each bit in the consecutive most probable symbol bits without checking the value of each bit.

19. The decoder of claim 18, further comprising:
receiving a context value, the Input compressed bitstream, and a CABAC decoder object, wherein the CABAC decoder object includes a range value and an offset value;
computing a sub-range value using the range value and the offset value;
computing a minimum number of consecutive most probable symbol bits (mpbits) in the input compressed bitstream;
returning a decompressed output bit having a value equals to a most probable symbol value, if the minimum number of consecutive most probable symbol bits is greater than zero; and
returning a decompressed output bit having a value equals to a least probable symbol value, if the minimum number of consecutive most probable symbol bits is equal to zero.

20. The decoder of claim 19, wherein returning the decompressed output bit having a value equals to the most probable symbol value, further comprising:
computing a new range value by subtracting the range value from the sub-range value;
performing a normalization process;
upon completion of the normalization process, checking if a zero bit is encountered in the consecutive most probable symbol bits;
iteratively advancing the state machine of the CABAC decoder for each bit in most probable symbol consecutive bits, if a zero bit is not encountered; and
returning a total number of decoded bits when the zero bit is encountered or a specified bit count is achieved.
